(19) United States
(12) Patent Application Publication
(10) Pub. No.: US 2006/0161816 A1
(43) Pub. Date: Jul. 20, 2006

(54) System and method for managing events

(76) Inventors: Ronald Joseph Gula, Marriotsville, MD (US); Renaud Marie Maurice Deraison, Columbia, MD (US); Matthew Todd Hayton, Silver Spring, MD (US)

Correspondence Address: MICHAEL BEDNAREK;PILLSBURY WINTHROP SHAW PITTMAN LLP, 1650 TYSONS BOULEVARD, MCLEAN, VA, 22102, US

(21) Appl. No.: 11/313,710

(22) Filed: Dec. 22, 2005

Related U.S. Application Data
(60) Provisional application No. 60/637,753, filed on Dec. 22, 2004.

(51) Int. Cl. G06F 11/00

(52) U.S. Cl. 714/39

(57) ABSTRACT

Systems and methods to manage logs from log sources distributed across one or more networks using a log event management system, herein called a Thunder console. The Thunder console is a log aggregator that allows networks to deploy servers which collect, normalize, and analyze a large number of log events. These logs can be stored for a specific period of time. Alerts can be generated to communicate information regarding the log events.

This application claims the benefit of U.S. Provisional Application No. 60/637,753, filed Dec. 22, 2004, which is herein incorporated by reference in its entirety.

### BACKGROUND

1. Field of the Invention

The present invention relates generally to systems and methods for managing computer network security events. More particularly, the present invention relates to systems and methods for analyzing any log event activity.

2. Background of the Invention

Almost all devices generate a log event of some sort. However, it is often very difficult to correlate logs from various places because each is often written in a different format. Even if a common format is provided for a particular technology, such as a common web log, transferring that log to a central location and correlating with other types of technologies is difficult. For example, there are thousands of different devices that generate logs, not to mention proprietary logs that are relevant only to selected customers.

In addition, many of these logs tend to repeat single events multiple times, creating a large file from which it is difficult to extract useful information. Further still, many of these logs do not analyze the events or otherwise indicate their importance.

Thus, it is desirable to collect logs from a variety of devices and provide log normalization and analysis for a variety of network devices and technologies.

### BRIEF SUMMARY OF THE INVENTION

The method for managing log events in a network, according to an embodiment of the preferred embodiment of the invention includes receiving a plurality of log messages in SYSLOG format from log sources across the network. From the plurality of log messages, log events are detected and then normalized. Normalized log events are analyzed. In one embodiment, the normalized log events are analyzed for complex sequences of events in firewall, web, router, server, and other types of logs. In another embodiment, statistical profiling is used on the data to detect trends or anomalies. The method for managing log events includes managing log events for a plurality of networks, such as a Class A network, a Class B network and a Class C network.

### BRIEF DESCRIPTION OF THE DRAWINGS

FIG. 1 is a schematic diagram of a network using a Thunder console according to a preferred embodiment of the present invention.

FIG. 2 is an exemplary asset schema according to a preferred embodiment of the present invention.

FIG. 3 is an exemplary schematic diagram of a system using a Thunder console according to a preferred embodiment of the present invention.

FIGS. 4A-4D illustrate various implementations of a Thunder console.

FIG. 5 shows an exemplary method for performing log analysis according to the present invention.

FIG. 6 shows a Thunder console display for a port summary tool according to a preferred embodiment of the present invention.

FIG. 7 shows a Thunder console display for a Class A network activity summary tool according to a preferred embodiment of the present invention.

FIG. 8 shows a Thunder console display for an IP address activity summary tool according to a preferred embodiment of the present invention.

FIG. 9 shows a Thunder console display for a unique event summary tool according to a preferred embodiment of the present invention.

FIG. 10 shows a Thunder console display for a time based activity summary tool showing all events according to a preferred embodiment of the present invention.

FIG. 11 shows a Thunder console display for a time based activity summary tool showing statistically significant events according to a preferred embodiment of the present invention.

FIG. 12 shows a Thunder console display for a list of specific events tool according to a preferred embodiment of the present invention.

FIG. 13 shows a Thunder console display for a display of raw event message tool according to a preferred embodiment of the present invention.

### DETAILED DESCRIPTION OF THE INVENTION

Embodiments of the present invention manage any log event data, including proprietary log formats. Particularly, a Thunder console consistent with the present invention may handle billions of logs from various devices and/or services, such as a firewall, an intrusion detection system (“IDS”), a system log, a honeypot, an application, an authentication, a switch and a router, among others. A log event management system, herein called a Thunder console, means a computer program having the functionality described herein. The Thunder console may perform log normalization for each of these various log sources through signature analysis. The Thunder console may analyze custom or commercial off the shelf signatures. In addition, the Thunder console allows a user to select particular events to analyze.

For example, in its simplest deployment option, various network devices may send events across one or more networks to a Thunder console via SYSLOG messages. When these events arrive at a Thunder server hosting the Thunder console, they are analyzed for a variety of potential signature matches. That is, the Thunder console parses logs from many different devices to determine whether it matches a particular stored signature. When the Thunder console detects a signature match, it logs the event with a normalized event name and extracts information, such as a source IP address and a destination IP addresses, from the event or log. Because events are normalized, each unique event appears only once in a list of log events at the Thunder console. The Thunder console stores the number of occurrences of a particular log event. The Thunder console analyzes the events as they occur. If an anomaly is observed in the logs, the Thunder console issues an alert.

In addition, the Thunder console may work in conjunction with a Lightning console to store events and perform analysis on behalf of Lightning console users, allowing correlation of log events with intrusion and vulnerability detections. A Lightning console is described in U.S. patent application Ser. No. 10/863,238, entitled “System and Method for Managing Network Vulnerability Systems,” by Gula et al. filed on Jun. 9, 2004, which is incorporated herein by reference. By combining the Thunder console with the Lightning console, users obtain vulnerability scanning, intrusion event analysis, security management and log analysis.

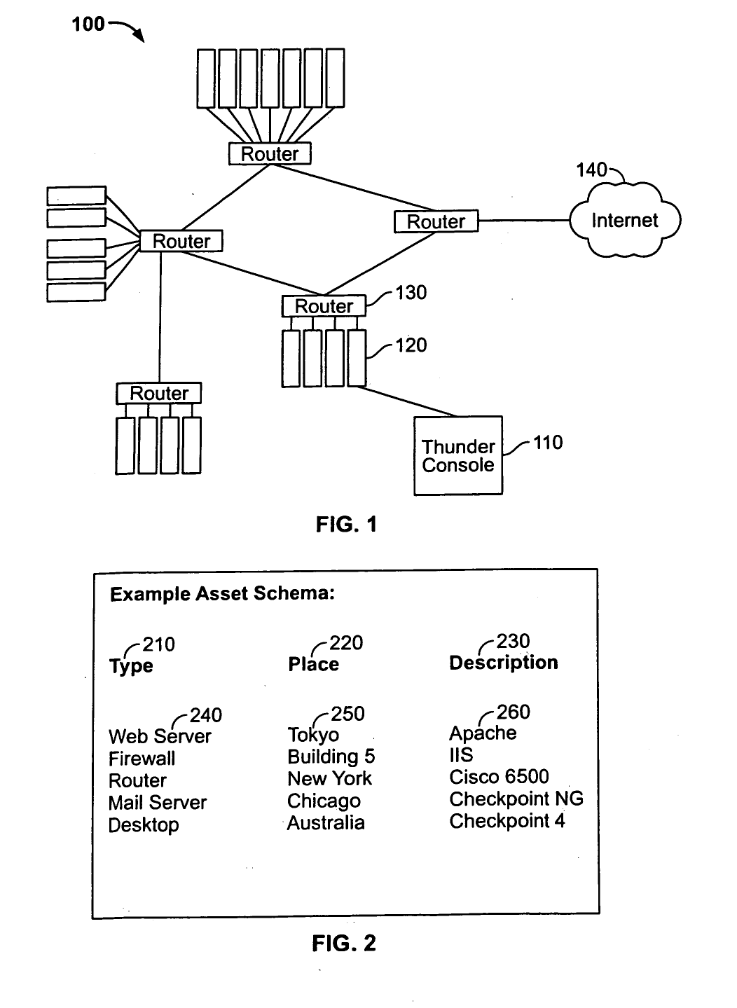

FIG. 1 is a schematic diagram of a network 100 using a Thunder console according to a preferred embodiment of the present invention. System 100 includes a Thunder console 110, a host 120, a router 130 and Internet 140. Routers 130 may forward communications from various hosts 120. Hosts 120 may communicate with one another or with other devices within a network by traversing one or more routers 130. One of ordinary skill in the art will recognize that network 100 may include or exclude various devices that issue log events to be analyzed by Thunder console 110, such as an IDS or a honeypot. Thunder console 110 analyzes log activity generated over a network by at least one host 120.

In a preferred embodiment, Thunder console 110 is deployed on a UNIX server with 2 to 4 GB of memory and 100 to 1000 GB of storage. However, one of ordinary skill in the art will recognize that Thunder console 110 may be installed on other types of servers having more or less memory and storage. For example, in an alternative embodiment Thunder console 110 is installed on a server with only 1 GB of memory.

In a preferred embodiment, Thunder console 110 is configured to process events from nearly 200 different log sources, including but not limited to sniffers, firewalls, servers, intrusion prevention systems (IPS), operating systems, network devices, applications, intrusion detection systems, honeypots, virus detection systems, authentication devices and network monitors.

Some exemplary firewalls and IPS that send events to Thunder console include, but are not limited to, the following: Checkpoint, PIX, CyberGuard, Gauntlet, Juniper, Astaro, Arkoon, TippingPoint, IntruSheild, Proventia, Fortinet, ipchains, iptables, ipfilter, Kerio, NetGear, OpenBSD's pf, SideWinder, SonicWall, PortSentry, Sygate, Symantec, Windows XP, V-Secure IPS Appliance, and aZoneAlarm.

Similarly, Thunder console 110 is configured to process events from each of the following exemplary operating systems: Linux, Solaris, Windows NT/2000/XP/2003, FreeBSD, and OS X. Likewise, Thunder console 110 is configured to process events from each of the following exemplary network devices: Apple Airport, Cisco IOS, Cisco Aironet, Enterasys, D-Link, 3Com, Foundry, Juniper, and DHCP leases.

Thunder console 110 also supports the following exemplary applications: Apache 1.x/2.x, arpwatch, bind, IMAP, Microsoft IIS, POP, ncFTP, Nessus, NeWT, proFTP, wu-IMAP, wu-FTP, Postfix, Qpopper, OpenSSH, Exim, Sendmail, and Trend Micro.

Thunder console 110 further is configured to process events from each of the following exemplary intrusion detection systems: AirMagnet, Bro, CimTrak, Dragon, IntruSheild, Lightning console correlated IDS events, Network Flight Recorder, Sourcefire, and Snort. Thunder console 110 is configured to process events from honeypots, such as ForeScout, Honeyd, La Brea, Symantec Decoy Server, virus detection programs, such as eTrust, Symantec, and Trend, and network monitors, such as Tenable Network Monitor, and Tenable NetFlow Monitor.

One of ordinary skill in the art will recognize that other devices not listed above may also be supported by Thunder console 110. For example, a device may include an ICE9 network sniffer by Tenable Network Security (Columbia, Md.). ICE9 network sniffer can be used to monitor network traffic and send real-time traffic flows to Thunder console 110. By forwarding network traffic, Thunder console 110 can compare network traffic logs with firewall, router, web and operating system logs. Unlike other sniffers which log packet-by-packet, ICE9 logs the entire flow, including a time a session is started, its length and the amount of traffic.

FIG. 2 is an exemplary asset schema according to a preferred embodiment of the present invention. Thunder console 110 may use one or more fields to identify a device, such as host 120 and router 130. Some exemplary fields include a type 210, a place 220 and description 230. A type 210 is a broad category descriptor of a network device. Some exemplary types 210 include a web server, a firewall, a router, a mail server, a desktop , an application, an authentication system, a honeypot, and an intrusion detection systems, among others. A place 220 may include a geographical location of the device. The place descriptor may be as broad as “Australia” or “Chicago” or as narrow as “Building 5.” Finally, a description 230 may provide more information regarding the type.

For example, Thunder console 110 may list “web server” 240 in a type field for a particular network device and “Apache” 260 in a corresponding description field for the device, indicating that the device is an Apache web server. “Tokyo” 250 indicates the Apache web server is located in Tokyo.

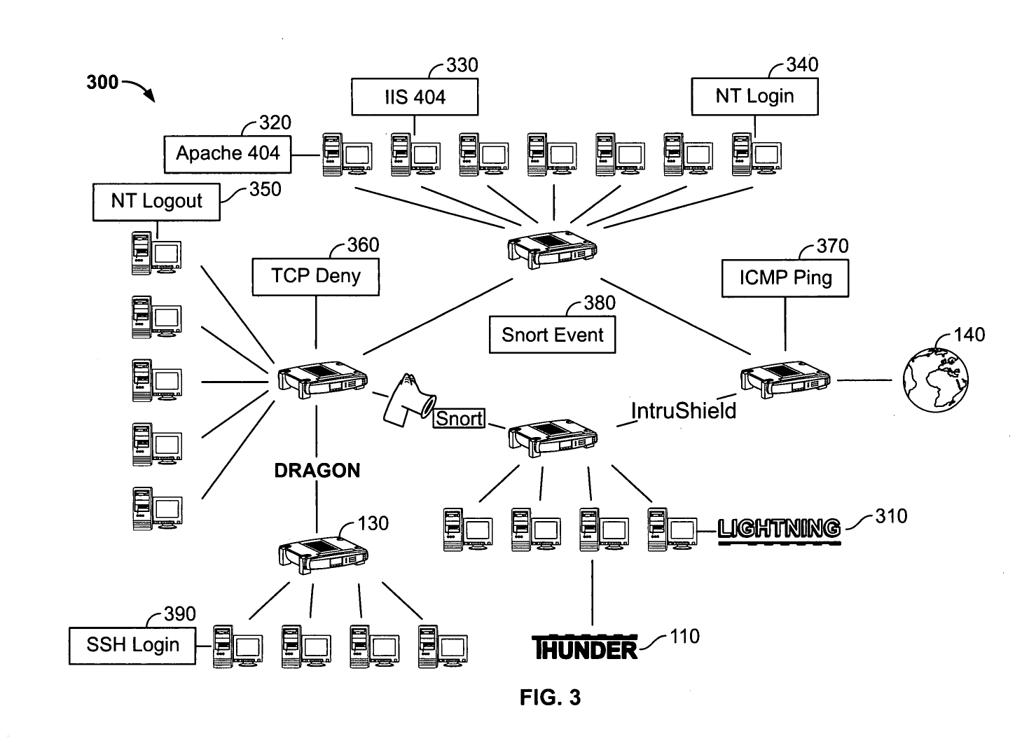

FIG. 3 is an exemplary schematic diagram of a system 300 using a Thunder console according to a preferred embodiment of the present invention. The exemplary system 300 further includes Lightning console 310, described in patent application Ser. No. 10/863,238 (previously referenced). As shown, Thunder console 110 is deployed on a secondary server to Lightning console 310, but could be deployed together. In a preferred embodiment, Lightning console 310 and Thunder console 110 have a trust relationship using secure shell (SSH) such that a specific user on Lightning console 310 can execute commands on Thunder console 110.

In one embodiment, a user of the Lightning console 310 queries Thunder console 110 with his security privileges and allows unique accounts to be configured that have limited access to the available data. A user who is a security administrator may have access to all router ACL logs and IDS events. In contrast, a user who is a DNS administrator would only be shown events for specific IP addresses in his range of administration. This configuration has several benefits.

Foremost, during an incident, all of the relevant logs are available for immediate analysis, including historical events as well those that occurred within the past 5 minutes. Although forensic log analysis is typically the job of the security expert, system administrators may recognize aberrations in the logs which may otherwise go unnoticed. An additional benefit to the configuration is that logs are available for performance, diagnostics, and troubleshooting. For example, having access to the firewall logs may help an email administrator troubleshoot the configuration of a high-availability server.

In one exemplary embodiment, Thunder console 110 adds a variety of reporting and analysis options to Lightning console 310. Although the preferred embodiment described herein includes a Lightning console 310, one of ordinary skill in the art will appreciate that in an alternative embodiment Thunder console 110 can stand alone in a network without Lightning console 310.

In system 300, Thunder console 110 aggregates, normalizes, trends and analyzes an Apache event 320, an Internet Information Services (IIS) event 330, an NT login event 340, an NT logout event 350, a TCP deny event 360, an Internet Control Message Protocol (ICMP) ping event 370, a snort event 380 and a secure shell (SSH) login 390, and data from Lightning console 310. Events 310-390 are just a few exemplary events that may occur during a short span of time of system 300.

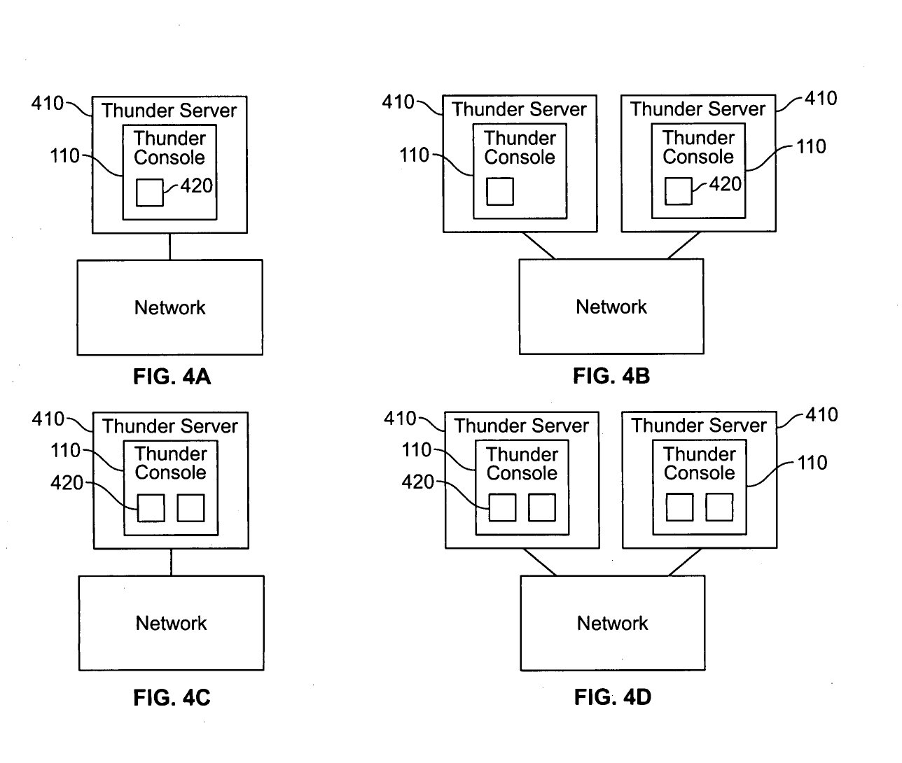

FIGS. 4A-4D illustrate various implementations of Thunder console 110. For example, one or more Thunder consoles 110 may be used to perform log aggregation, normalization and analysis.

FIG. 4A illustrates a Thunder console implementation according to a first preferred embodiment of the present invention. FIG. 4A shows Thunder console 110 exists on a dedicated server 410 (herein called a “Thunder server”). In a preferred embodiment, all execution and analysis of Thunder data occurs on the Thunder server.

FIG. 4B illustrates a Thunder console implementation according to another preferred embodiment of the present invention. FIG. 4B shows a plurality of Thunder servers 410 connecting to a network. Each Thunder server 410 has a Thunder console 110. Using multiple Thunder servers 410 spreads the processing load. For example, each Thunder server 410 may receive events from a portion of the network. According to a preferred embodiment of the invention, one Lightning console 310 is configured to work with multiple Thunder servers. However, a particular Lightning console customer may be configured to use all of the Thunder servers or only a specific Thunder server.

In the embodiments shown in FIGS. 4A and 4B, Thunder console 110 employs a single CPU machine 420. However, in a preferred embodiment of the invention, Thunder console 410 employs multiple CPUs.

FIG. 4C shows Thunder console 110 exists on a single dedicated server 410. However, Thunder console 110 uses a plurality of CPU machines 220. By using a plurality of CPUs, Thunder console 110 reduces its load. For example, if two CPUs are employed, one CPU may be dedicated to event processing while another may perform queries with Lightning console 410. In many cases, using a plurality of CPUs provides a greater performance increase than simply upgrading to a faster processor speed.

FIG. 4D illustrates a Thunder console implementation according to another preferred embodiment of the present invention. FIG. 4D shows each Thunder server 410 has a Thunder console 110 and any Thunder console 110 may have a plurality of CPUs 420.

One of ordinary skill in the art will recognize that the Thunder console of the present invention is not limited to any particular server deployment. For example, in an alternative embodiment Thunder console 110 may exist on a shared server, rather than a dedicated server.

Thunder console 110 does not require a database. However, one of ordinary skill in the art will recognize that a database may be employed if desired.

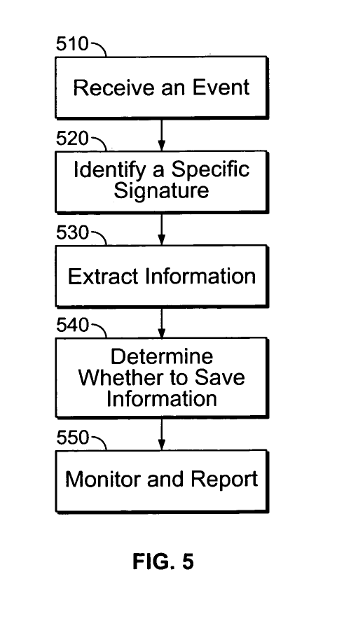

FIG. 5 shows an exemplary method for performing log analysis according to the present invention. In step 510 Thunder console 110 receives events from a plurality of different hosts. Feeding data to Thunder console 110 requires data manipulation, as devices output data using an assortment of transport mechanisms. For example, Check Point Software Technologies firewalls are typically configured to output their log information using Open Platform for Security (OPSEC) or Simple Network Management Protocol (SNMP). By comparison, Cisco IDS devices default to using the proprietary Cisco Post Office Protocol (POP), but they can also be configured to use SNMP as their transport mechanism.

In a first preferred embodiment of the present invention, a Thunder server 410 acts as a SYSLOG server, receiving and processing SYSLOG messages from any device which sends its messages. SYSLOG messages are produced by hosts, such as routers, switches, wireless access points, UNIX servers forwarding their system events, Windows servers running any number of popular SYSLOG utilities and any other SYSLOG enabled device, such as those described above with reference to FIG. 1. In addition, SYSLOG messages or protocols are often the lowest common denominators for inter-device communication, making them a suitable candidate for use by Thunder console 110 in data analysis and normalization.

In a second preferred embodiment of the present invention, Thunder server 410 is configured to receive SYSLOG, Windows NT and OPSEC events.

In an alternative embodiment or in addition to the first preferred embodiment, agents may be used to securely send events to the Thunder console 110 (step 510).

For example, Thunder agents harvest data on devices and forward the data to aggregation points over a secure connection. Thunder servers 410 receive events from Thunder agents via a secure API during an authenticated and encrypted network session. In a preferred embodiment, a Thunder agent must have a specific IP address and shared secret before events can be forwarded into the Thunder server 410. Expanding the number of devices forwarding data to Thunder server 410 is a simple matter of configuring a shared secret between each client and server.

Thunder agents may bundle events found in flat log files, open platform for security (“OPSEC”) protocols, network sessions and Windows events. In particular, Thunder agents perform the necessary conversion from an API used to receive log messages to Thunder's secure API used to forward the events to the Thunder server 410. Some of the agents are simple secure log forwarders, while others, such as a Windows agent, will attempt to convert NETBIOS names to real IP addresses.

After receiving one or more events at step 510, Thunder console 110 identifies a particular signature (step 520) and extracts information from the event log (step 530). More specifically, when SYSLOG events arrive at a Thunder server 410, they are analyzed for a variety of potential signature matches. Identifying a specific signature applied to the log message is a specific form of event normalization. Thunder console 110 preferably uses high-speed regular expressions to identify logs of interest. If a signature matches, Thunder console 110 will extract information, such as source and destination IP addresses, ports, protocols and other details contained in the log message.

As Thunder receives these events, for each log source or host on the network, it computes a normal event load and the amount of time the log source is acting as a client or server. More interestingly, events that are only slightly statistically significant can be used as pointers to understand “normal” network behavior, because network usage, load, and communication flows often change on a daily basis.

Thunder console 110 then uses statistical profiling of each log source or host to identify changes in expected behavior. By analyzing what logs are normal for each server that it monitors, Thunder console 110 detects when a swing in normal behavior or an anomaly is observed.

If there are swings in the “normal” loads, alerts may be generated. For example, alerts are generated if there is an abnormal increase of any event type, an increase in the number of connections observed, or a dramatic change in client or server behavior. Thunder console 110 issues a report or an alert to an appropriate person, such as a network administrator or security administrator.

Thunder console 110 removes multiple instances of a single event. Multiple occurrences of an event can be tabulated in one unique log entry.

In a preferred embodiment, Thunder console 110 is configured to normalize only those log events that are relevant to understanding an overall security posture. For example, Thunder console 110 may normalize only intrusion detection, firewall and Windows security events.

Thunder console 110 supports many forms of logging formats. For example, as discussed above with reference to FIG. 1, Thunder console 110 currently supports nearly 200 devices. However, there are thousands of devices that generate logs, many of which use a unique formatting scheme. Further, some devices even generate proprietary logs for specific customers. To handle such unknown log formats, Thunder console 110 allows a user to develop a custom signature analysis. For example, a user may create an expression to identify of log an event of interest based upon knowledge of the user regarding a log event that is not known by Thunder console 110 using a Thunder Application Scripting Language (TASL).

The signature writing software of Thunder console 110 is similar to JAVA and the Nessus Attack Scripting Language (NASL). NASL is a signature detection software used by Snort, a network-based IDS that uses signature detection. A person who can write scripts in NASL can write scripts in TASL.

In step 540 Thunder console 110 determines which logs to save. In a preferred embodiment, Thunder console 11 stores information extracted and normalized during a signature analysis, rather than storing all received log events. In one example, Thunder console 110 analyzes 100 million log events per day at an organization having ten Checkpoint firewall logs and determines that only 25 million per day are log denies. Thunder console 110 stores only the 25 million log deny events per day for further analysis and correlation with intrusion detection logs, and discards the remaining 75 million log events per day. The retained log events are stored at a centralized location, such as a Thunder server 410, for a specified amount of time.

In another example, Thunder console 110 receives an event from a Windows 2000 server and performs a signature analysis to determine whether the event is a specific security-relevant event. If the event is critical, it is saved by Thunder console 110. Non-critical events, such as a message generated by the Windows 2000 server during boot-up or during system maintenance, do not match the signature and are not saved by Thunder console 110.

In an alternative embodiment of the present invention, other storage rules are created within Thunder console 110. For example, Thunder console 110 may aggregate all logs to a single Thunder server 410, regardless of content or significance. Even logs that are not recognized by a library of Thunder console 110 (that are not normalized) can be saved to a local file system, a second disk array or a storage area network. For many organizations, being able to easily retain their network and server logs for a given amount of time is a key facet of achieving regulatory compliance. By saving all logs while normalizing only those logs relevant to security, the Thunder console allows for efficient analysis of the security events while retaining logs. When bundled with Thunder and Lightning's ability to process that same set of data for each network and security administrator, those logs also become a useable forensic resource.

Tools provided at the Thunder console 110 are configured to analyze and monitor extracted log event data for particular situations or anomalies (step 550). As events are collected, Thunder console 110 looks for complex sequences of events in firewall, web, router, server, and other types of logs. If a complex sequence occurs indicating a security threat, Thunder console 110 issues an alert.

A user of Thunder console 110 can create a TASL script to perform advanced event correlation. For example, a user can create a TASL script to allow Thunder console 110 to look for worm outbreaks, detect wireless access points misuse, correlate IDS events to find compromises, and provide threshold alarms for specific event type. The TASL language is also very similar to the Nessus Attack Scripting Language (NASL) to allow anyone who is familiar with vulnerability plugins to write TASL scripts.

For example, each of the following scenarios can be programmed with a simple TASL script: alerting if there have been more than 100 SSH login failures within 5 minutes; alerting if there have been more than 10 authentication failures, as wall as a successful login and a password change (a common phishing technique); alerting if two different types of Network Intrusion Detection Systems (NIDS), such as Intrushield and Snort, see similar normalized attacks; alerting if a specific network generates any outbound events; detecting when “worm” IDS events have infected a host on the monitored network; alerting on IDS events which have occurred; alerting on large numbers of web “404” failures from a single host; alerting on large numbers of TCP sessions (firewall or sniffed) from specific external networks (which may indicate known hostile probing or scanning).

When TASL scripts generate new events, they can be fed back into Thunder for analysis by other TASL scripts, sent as an IDS event to the Lightning Console for alerting, sent as an email to a specific user list, or simply invoke a custom program.

Thunder console 110 provides various tools for manipulating and managing log information, including, but not limited to, a port summary tool, a Class A network activity summary tool, a Class B network activity summary tool, a Class C network activity summary tool, an IP address activity summary tool, an unique event summary tool, a time based activity summary tool, a unique event type summary tool, a protocol summary tool, a list of specific events tool, a date summary tool, and a display of raw event message tool. One of ordinary skill in the art will recognize that Thunder console 110 may include any combination of the tools described above, as well as additional tools not disclosed herein.

In a preferred embodiment, the tools of Thunder console 110 provide for reporting and direct analysis via a web interface. Reports are produced upon demand and delivered in an HTML and PDF format. For example, a user may select various output screens for inclusion in a report. Alternatively, reports may be provided automatically at periodic intervals.

From within the web interface, events are analyzed in an interactive session.

Subsequent queries initiated by a user isolate events of interest. Each of the tools of Thunder console 110 produce one or more graphical user interfaces for convenient and user-friendly implementation. For example, a user may summarize a list of events, select a specific event, display a number of those events over time and finally observe a ‘spike’ of those events at a given moment. An example includes a Thunder console 110 characterizing all logon or logoff events as an event type of ‘log failures.’ In this instance, the Thunder console 110 would be able to graph all ‘log failures’ over time. A high spike may indicate an instance of brute force password cracking.

In a preferred embodiment, Thunder console 110 is used by users of the Lightning console 310. When one or more Thunder consoles 110 are deployed with a Lighting console 310, users may analyze vulnerabilities, intrusion events and log events from one web interface. Thunder console 110 extends the same tools and reporting functionality provided the Lightning console 310 to analyze log events.

Thunder console 110 also facilitates outbound queries to other sources of information. For example, while analyzing event log data, various interfaces present the user with Domain Name Service (DNS) lookups, American Resource for Internet Numbers (ARIN) searches and event SysAdmin, Audit, Network, Security (SANS) reports on reported abuse of specific ports and networks. Within Lightning console 310, Thunder console 110 can be searched. In one example, a user who observes a specific Snort event is presented with an option to query Thunder's logs for any matches on the associated source or destination IP addresses.

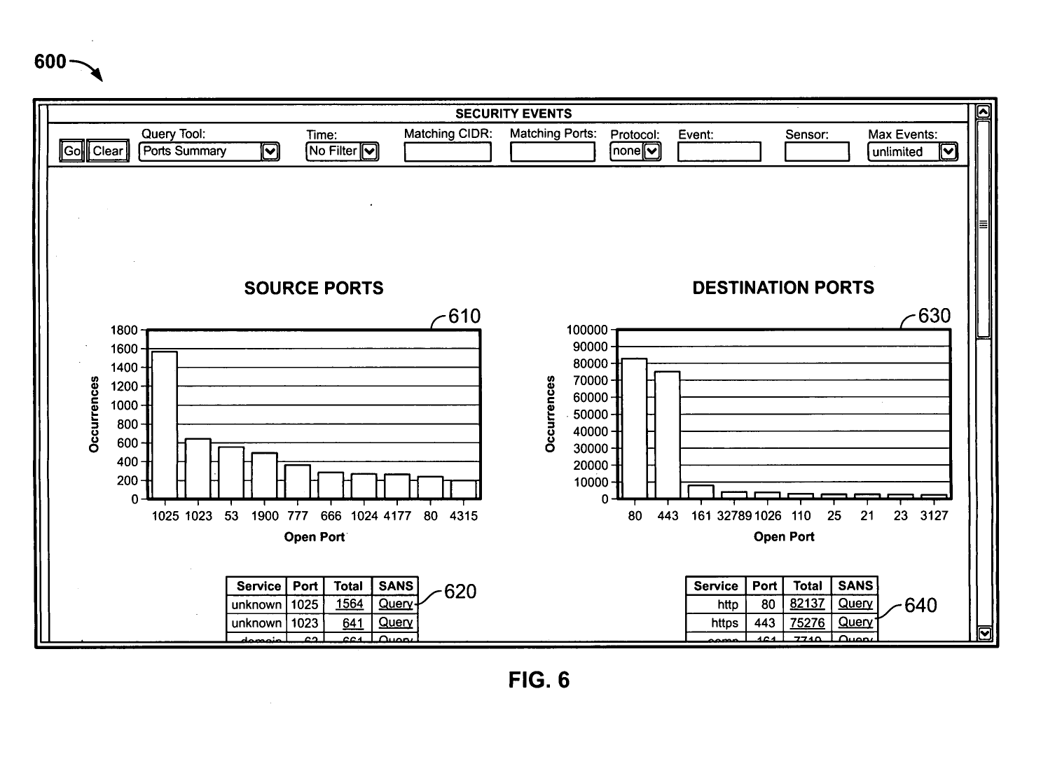

FIG. 6 shows a Thunder console display for a port summary tool according to a preferred embodiment of the present invention. The port summary tool 600 summarizes information relating to source ports and destination ports in graphs 610, 630 and tables 620, 640. For example, graph 610 indicates the number of matching events (i.e., an event that matched a Thunder signature) at each open source port an event in Thunder for a particular network.

The corresponding table 620 provides the information in tabular format. For example, source port 1025 listed in table 620 indicates a total of 1564 occurrences of an event. In this instance, an identifying service of the event is labeled “unknown.” However, in other instances, a service may be identified, such as a domain or http service. A SANS column allows a user to make a SANS query to an internet storm center (i.e., SANS resource for an Internet's warning system) to check whether anyone has reported activity from a particular port.

In a preferred embodiment of the present invention, a user can “drill” into the data provided in graphs 610, 630 and table 620, 640 (and each of the tools provided by Thunder console 110) to obtain more specific or lower level information. For example, graphs 610, 630 provide an overview of the number of occurrences of an event for each open port, but a user may click on a particular port depicted in one of the overview graphs to obtain more information specific to that port. Similarly, tables 620, 640 also are hyperlinked so that a user can click a cell within table 620 to dig for additional information. For example, a user clicking on a cell in a “total” column within table 620 is taken to another screen to view each occurrence for a particular, corresponding port.

Each tool provided by Thunder console 110 provides a graphical interface allowing a user to interact with the port summary tool. For example, a toolbar at the top of tool 600 allows a user to filter data over all time, a range of time or at a specific instance of time. Further, a user can use the toolbar to search for a particular event, port, Classless Inter-Domain Routing (CIDR), or sensor. In one embodiment, the toolbar provides a drop-down menu for selecting a particular tool. The graphical user interface allows a user to drill for more specific information within each tool. For example, tool 600 provides an overview regarding source ports and destination ports, but a user can click within the graph 610, 630 or table 620, 640 to obtain further information about a particular port. The tool allows a user to continue to dig into the data to find more specific information if desired.

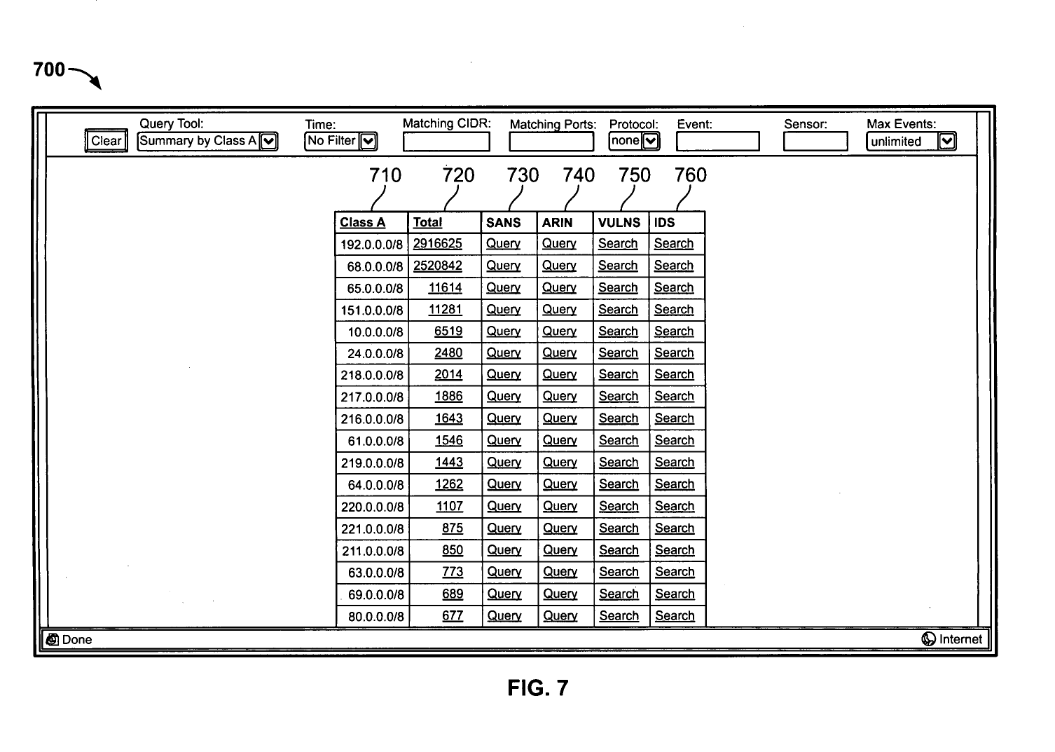

FIG. 7 shows a Thunder console display for a Class A network activity summary tool according to a preferred embodiment of the present invention. The Class A network activity summary tool lists all active IP addresses 710 of Class A. Class A/B/C networks are similar to an area code or zip code for IP addresses on the Internet. Summarizing IP addresses on a class A, B or C network allows a user to work efficiently with larger numbers of IP addresses.

A total column 720 lists the total events at each IP address in Class A as a hyperlink. Clicking a hyperlink in total column 720 provides further information regarding each of the entries forming a total. For example, clicking a total cell for Class A IP address “192.0.0.0/8” having a value of “2916625” creates a new screen listing the 2916625 entries logged at this address.

A SANS column 730 invokes a query to an internet storm center (i.e., SANS resource for an Internet's warning system) to check whether anyone has reported activity from that Class A network. In particular, a user may click on a hyperlink in the column to perform a SANS query for a particular IP address. An ARIN column 740 provides a similar lookup to make an ARIN request. VULNS column 750 and IDS column 760 relate to vulnerabilities and IDS events, respectively, recorded by Lightning console 310. In this manner, log events can be correlated with detected vulnerabilities or attacks on a system.

A Class B network activity summary tool and a Class C network activity summary tool are similar to a Class A network activity tool, except that they are directed to Class B and C networks, respectively.

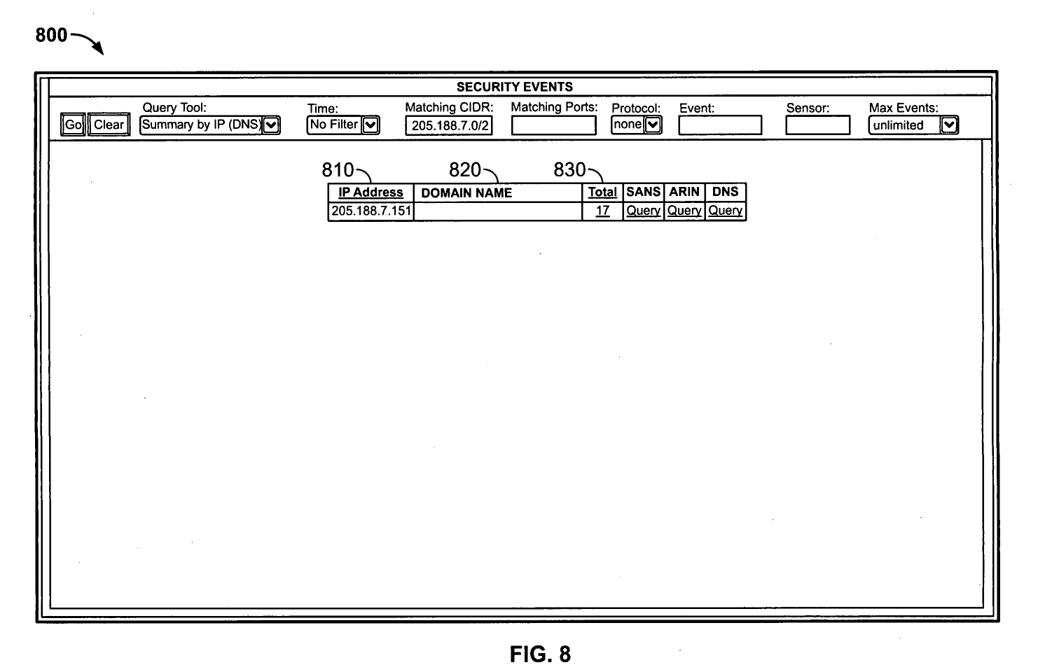

FIG. 8 shows a Thunder console display for an IP address activity summary tool according to a preferred embodiment of the present invention. The IP address summary tool 800 lists all IP addresses 810. In FIG. 8, only one IP address 810, 205.188.7.151, is provided. Although a domain name is not provided for this address in domain column 820, another IP address may list a domain name, such as http://www.tenablesecurity.com into its proper IP address.

Total column 830 indicates that IP address 205.188.7.151 has 17 recorded events. If a user clicks on the total of 17 shown for this IP address, he may probe into the layers of log data to find each of the 17 event logged for this address.

SANS column, ARIN column, and DNS column each provide a query related to SANS, ARIN and DNS, respectively. For example, a DNS query may determine an IP address for a particular domain name.

As with the other tools, a user may interact with the IP address summary tool to modify the data provided. For example, a user can specify a time range, ports, an event, censor or CIDR to monitor.

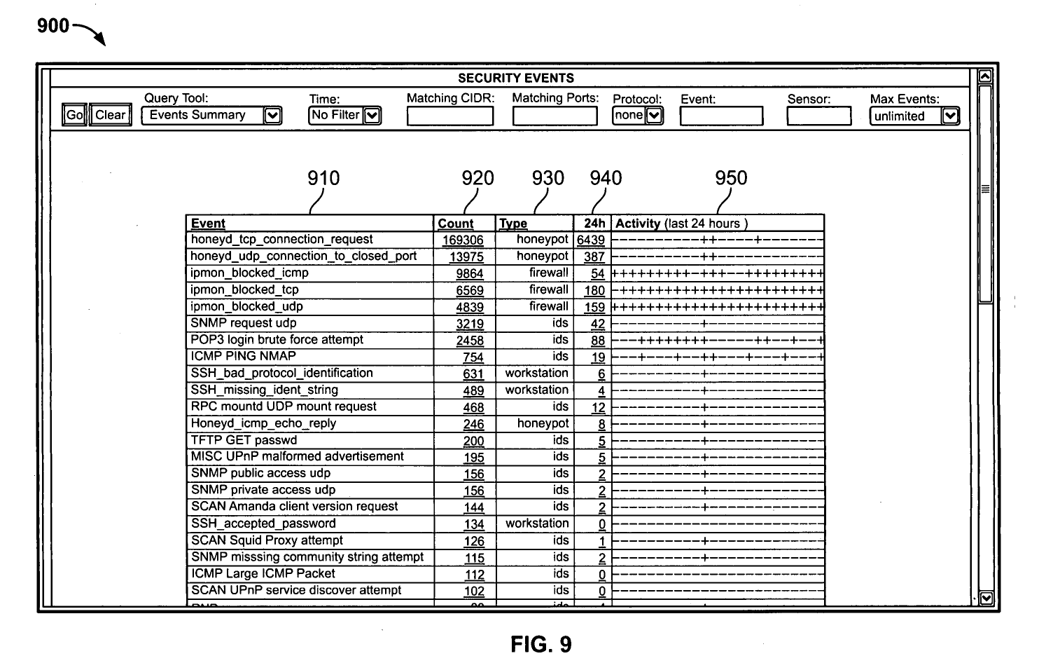

FIG. 9 shows a Thunder console display for a unique event summary tool according to a preferred embodiment of the present invention. Event summary tool 900 includes an event column 910 of normalized log events. That is, log events (deemed worthy of extraction and storage) are normalized such that each unique event is listed once in column 910. A count column 920 records the number of times each normalized event occurs with Thunder server 410. A type column 930 classifies the event as a particular event, such as an intrusion or user activity. One of ordinary skill in the art will recognize that various types can be defined within Thunder console 110 according to the interests of the user.

A 24 h column 940 lists a number of matching events within the last 24 hours. For example, a normalized event “honeyd_tcp_connection_request,” which occurs over 150000 times and having a type “honeypot” occurred 6439 times in the last 24 hours. An activity column 950 depicts the frequency of event activity within the last 24 hours. Any hour that had one or more events is marked with a “+” sign. In this example, three hours of the last 24 hours had activity.

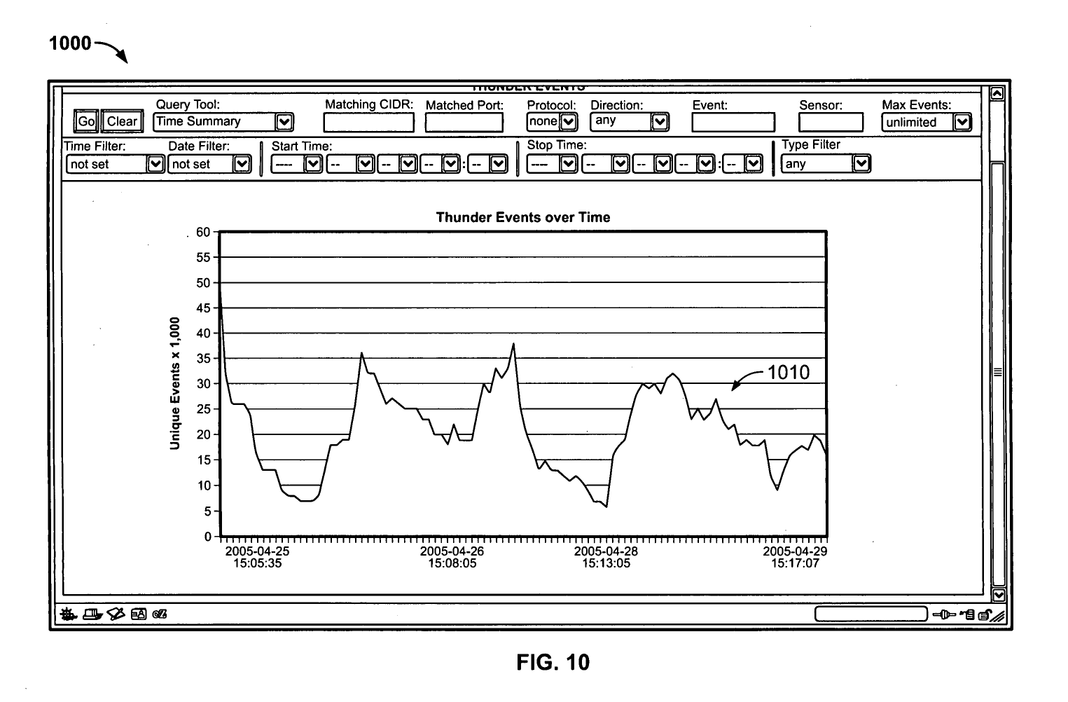

FIG. 10 shows a Thunder console display for a time based activity summary tool showing all events according to a preferred embodiment of the present invention. Time based activity summary tool 1000 summary tool provides a time profile of all matching events. The graph 1010 shown in 1000 is interactive. A user may click anywhere on graph 1010 to zoom on any spike or time period or receive further information regarding a particular time period. For example, clicking at a particular point (or range) in time zooms on the area of the graph and/or provides information in text regarding the number of events at that point (or range) in time.

Graph 1010 is a snap shot of three days of network sessions and Windows 2000 server event logs. The graph shows some easily recognizable peaks and valleys which correspond with business hours and off hours. However, this is a plot of all aggregate events and it does not capture anything out of the ordinary for specific servers.

As described above with reference to FIG. 5, as Thunder receives events, for each host on the network, it computes the normal event load and the amount of time the host is acting as a client or server. If there are swings in these “normal” loads, alerts can be generated. More interestingly, events that are only slightly statistically significant can be used as pointers to understand “normal” network behavior, because network usage, load, and communication flows often change on a daily basis.

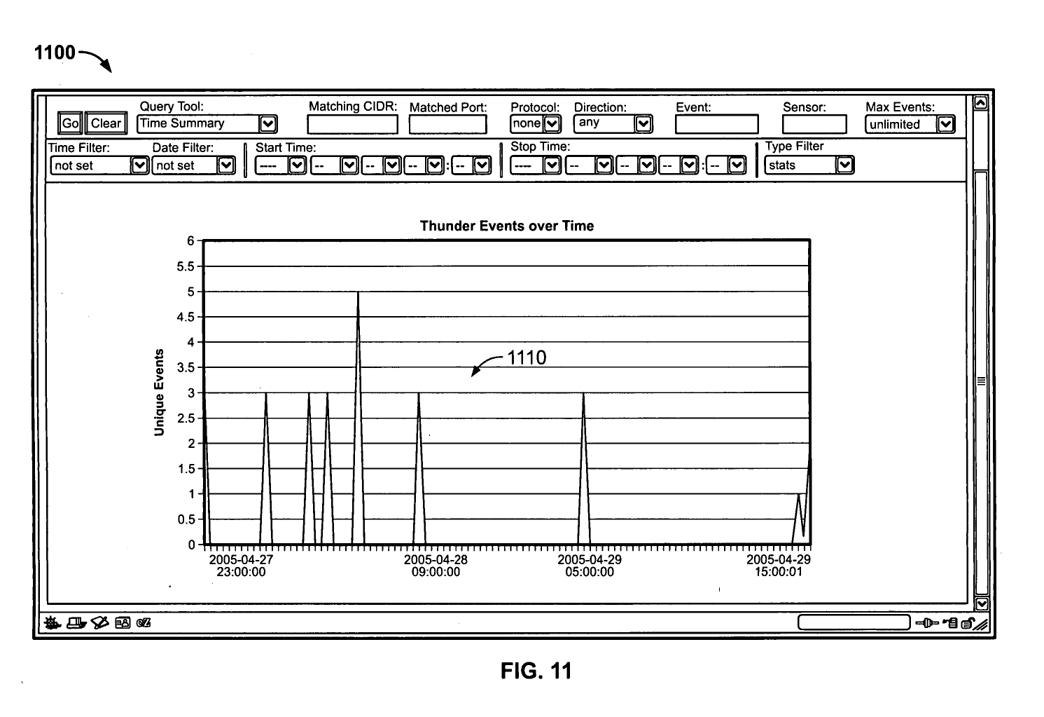

FIG. 11 shows a Thunder console display for a time based activity summary tool showing statistically significant events according to a preferred embodiment of the present invention. Graph 1110 in FIG. 11 shows seven distinct spikes for the same time period displayed in the graph 1010. If desired, the user could “drill” into this display to browse the specific logs which contributed to generate these alerts. These spikes indicate changes in the flow of network data and can indicate alterations in user patterns, network load shifts, and security events.

A protocol summary tool (not shown) provides a list of specific protocols captured by the Thunder console 110. A date summary tool (not shown) provides a number of events for a particular date or range of dates. The date summary tool allows a user to select events from a particular IP address or a particular network, such as a Class A, B or C network. The date summary tool also provides a 24 h column, similar to 24 h column 940 of FIG. 9.

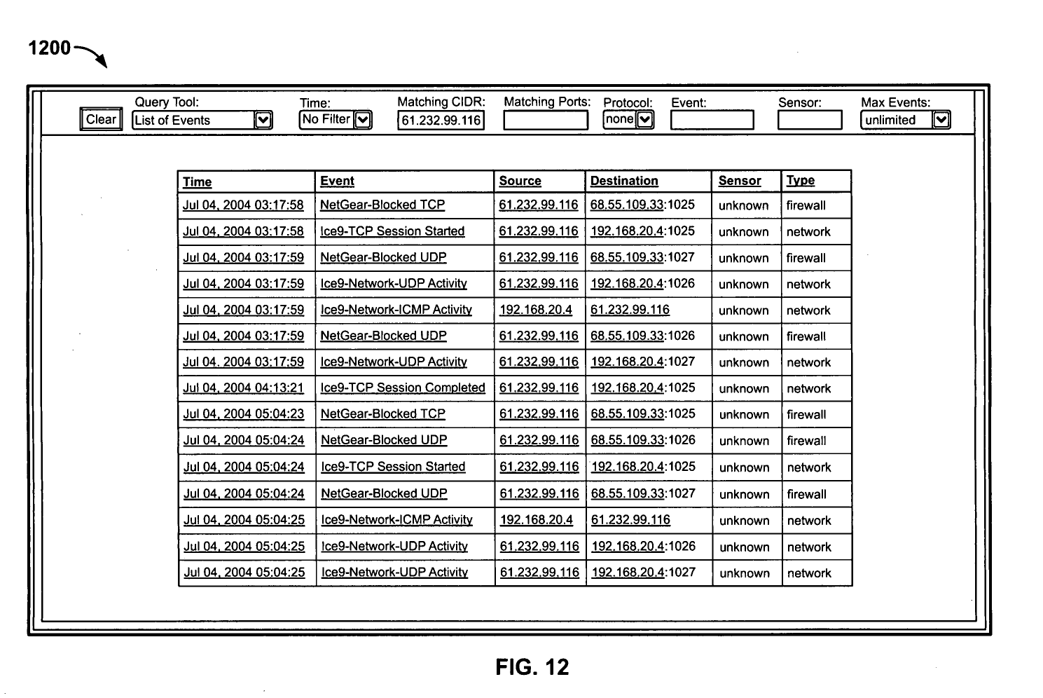

FIG. 12 shows a Thunder console display for a list of specific events tool according to a preferred embodiment of the present invention. Specific events tool 1200 lists specific events for a particular IP address or network range. For example, a user may choose to look at events from a particular IP address or an entire Class A network by changing the address in a CIDR field on the tool 1200. As with the other tools, a user may change a time filter for viewing the data.

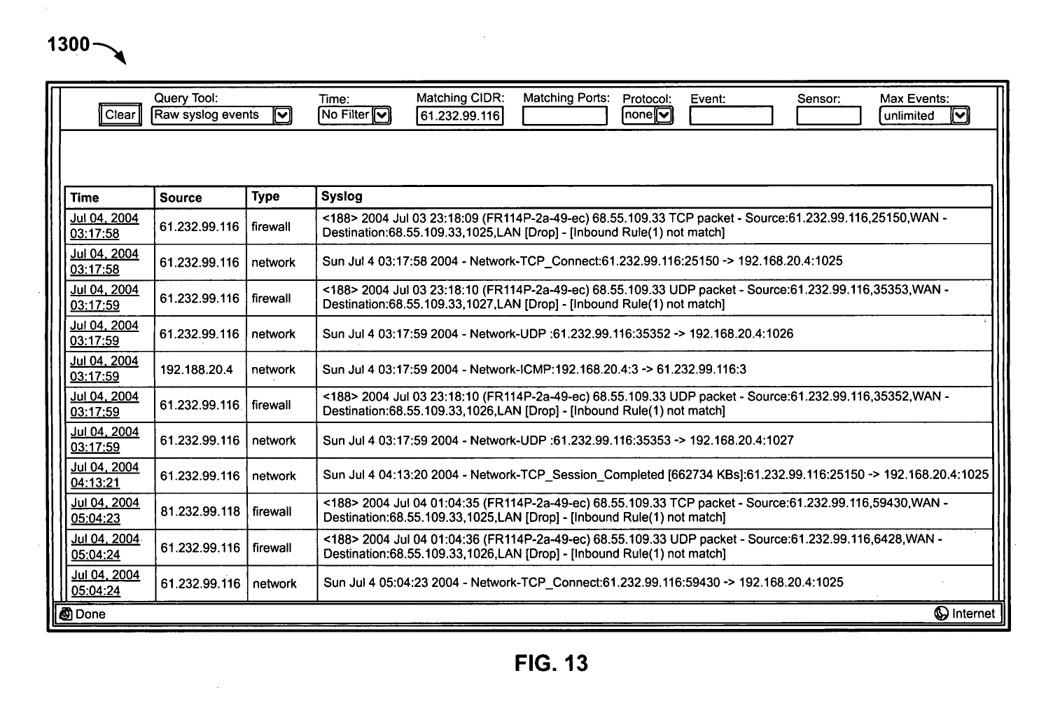

FIG. 13 shows a Thunder console display for a display of raw event message tool according to a preferred embodiment of the present invention. Raw event message tool 300 provides the actual SYSLOG messages for each offending IP address.

From within Lightning console 310, a user also can view Thunder log event data. In particular, Lightning console 310 has a set of tools (described in patent application Ser. No. 10/863,238) for viewing intrusion and vulnerability information. In a preferred embodiment of the present invention, these tools include a LOGS link to search for Thunder events at any time that correspond or link with an IDS event or vulnerability detected by Lightning console 310. Similarly, the tools include information regarding source and destination logs. In one example, a user who observes a specific Snort event, is presented with an option to query Thunder's logs for any matches on the source or destination IP addresses associated.

Because in the preferred embodiment the log events are not written to a SQL database, Thunder console 110 accepts SYSLOG messages from multiple sources and processes the events at an extremely fast events-per-second rate. The actual performance in any network will be determined by the number of events being analyzed, the actual number of events per second, the speed of the CPU (or CPUs) analyzing the data and the overall speed of the underlying Thunder system. In a preferred embodiment, a Thunder server 410 includes dual P4 systems with 4 GB of memory to analyze 250 million stored events in just a few seconds.

Thunder allows any user of the Lightning console to work with nearly one billion correlated and normalized events. Depending on the network and type of log activity, this may result from more than ten to one hundred billion raw log events. Unlike other SIMs and log management tools, all normalized events are available for analysis at any one time. With the system configuration described above, a majority of the reporting and analysis tools complete their complex operations in under two seconds. Where performance is an issue, multiple Thunder servers 410 can be used to dramatically increase their performance.

In summary, the Thunder console of the present invention has many powerful features which include allowing networks to centralize, analyze, and share log information for compliance, incident response, intrusion detection, and performance monitoring. One or more Thunder servers can be deployed with any Lightning console. With the Thunder console of the present invention, an organization obtains a centralized log analysis and vulnerability management into one user experience.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for managing log events in a network, comprising:
receiving a plurality of log messages in SYSLOG format from log sources across the network;
detecting log events from the plurality of log messages;
normalizing detected log events to generate normalized log events; and
analyzing the normalized log events.

2. The method of claim 1, further comprising:
communicating an alert when a deviation occurs.

3. The method of claim 1, wherein analyzing includes correlating the normalized log events with intrusion events and vulnerability information.

4. The method of claim 1, wherein normalizing includes using statistical profiling.

5. The method of claim 1, further comprising receiving at an agent bundled log messages; and
detecting log events from the bundled log messages.

6. The method of claim 1, wherein the log sources include at least three sources from the group: firewalls, intrusion prevention systems, operating systems, network devices, applications, intrusion detection systems, honeypots, virus detection systems and network monitors.

7. The method of claim 1, wherein normalizing includes determining whether a log event is unique.

8. The method of claim 1, wherein detecting includes extracting source and destination IP addresses.

9. The method of claim 1, wherein normalizing includes computing a normal load for each log source.

10. A system for managing log events in a network, comprising:
a plurality of log sources distributed across the network; and
a centralized log aggregation system for receiving a plurality of log messages in SYSLOG format from the plurality of log sources,
wherein the centralized log aggregation system detects log events from the plurality of log messages, normalizes detected log events to generate normalized log events, and analyzes the normalized log events.

11. The system of claim 10, wherein the centralized log aggregation system communicates an alert when a deviation occurs.

12. The system of claim 10, wherein the centralized log aggregation system correlates the normalized log events with intrusion events and vulnerability information.

13. The system of claim 10, wherein the centralized log aggregation system uses statistical profiling to normalized log events.

14. The system of claim 10, further comprising:
a first agent for receiving, processing and forwarding bundled log messages from a log source or a second agent to the centralized log aggregation system.

15. The system of claim 10, wherein the plurality of log sources include at least three sources from the group: firewalls, intrusion prevention systems, operating systems, network devices, applications, intrusion detection systems, honeypots, virus detection systems and network monitors.

16. The system of claim 10, wherein the centralized log aggregation system determines whether a log event is unique when normalizing.

17. The system of claim 10, wherein the centralized log aggregation system extracts source and destination IP addresses when detecting.

18. The system of claim 10, wherein the centralized log aggregation system computer a normal load for each log source when normalizing.
